(19) United States
(12) Patent Application Publication
(10) Pub. No.: US 2011/0065856 A1
(43) Pub. Date: Mar. 17, 2011

(54) REACTIVE SURFACTANTS FOR WATERBORNE RESINS

(76) Inventor: Michael J. Anchor, Canton, MI (US)

(21) Appl. No.: 12/992,336

(22) PCT Filed: May 11, 2009
(86) PCT No.: PCT/US09/43437

§ 371 Date: Nov. 12, 2010

Related U.S. Application Data
(60) Provisional application No. 61/052,726, filed on May 13, 2008.

(51) Int. Cl. C09D 167/08

(52) U.S. Cl. 524/539; 524/601

(57) ABSTRACT

Aqueous alkyd resin dispersions contain an emulsifying surfactant containing an unsaturated moiety which is reactive with the alkyd resin during cure of the resin. The surfactants are non-blooming and thus enhance the surface properties as well as substrate adhesion properties.

### CROSS-REFERENCE TO RELATED APPLICATIONS

This application claims the benefit of U.S. provisional application Ser. No. 61/052,726 filed May 13, 2008.

### BACKGROUND OF THE INVENTION

1. Field of the Invention

The subject invention pertains to aqueous alkyd resin emulsions containing non-fugitive, reactive emulsifying surfactants.

2. Background Art

While no longer the largest volume vehicles in coatings, alkyd coatings made still are of major importance. Alkyd resins are made from a polyol, phthalic anhydride and unsaturated fatty acids such as linseed fatty acid, soya fatty acids or tung fatty acids. These fatty acids are known as drying oils. Alkyd resins are commonly used in coating applications.

Alkyd coatings are relatively inexpensive coatings and perform well, with fewer film defects than other coatings. They are used in many industrial and architectural applications. The hydrophobic nature of the polymer makes the typical alkyd polymer coating used in oil based or solvent systems.

The current problem with alkyd coatings is the high level of VOC, volatile organic compounds, in typical solvent borne coatings. In recent years, the U.S. EPA has passed stringent regulations mandating severe reductions of VOCs in alkyd coatings. Additional restrictions of VOC in coatings will be enacted in the U.S. The European Community has mandated that solvent borne alkyd coatings be limited to 50 g/1 VOC by 2010, thus effectively eliminating solvent borne alkyd coatings in that area.

There are several types of alkyds. The main classification is into oxidizing and nonoxidizing types. This invention is mainly concerned with the oxidizing types. Oxidizing alkyds cross-link by the same mechanisms as drying oils cross-link, that is, cross-linking through double bonds and preferably through conjugated double bonds.

New technology has been recently developed to render solvent borne alkyd coatings more environmentally acceptable by trying to replace the solvent with water.

Alkyd resins are converted into useable waterborne products by one of two methods. One method is to graft an alkyd resin onto a latex polymer. The latex polymer and the additives that are used to facilitate the process render the latex/alkyd polymer dispersible in water. This gives the coating a blend of the two polymer types. The latex polymer and the additives that are used to make the latex polymer provide water dispersability to the product, while the grafted alkyd renders alkyd type properties such as toughness and resistance to various chemicals to the polymer. Additional processing steps are needed to make these products. The alkyd polymer needs to be of a particular type and structure in order to make a viable alkyd/latex coating. In some cases, the durability of these products is superior to those of latex polymeric coatings, but the alkyd resin chemistry must be altered to maximize the benefits of the grafted alkyd resin onto the latex backbone. These additional processing steps add cost to the product. This process employs additives such as surfactants and coalescing solvents to improve properties such as flexibility of the coating.

Emulsification of the alkyd resin is the other method to render the coating water dispersible and therefore reduce or completely remove all of the VOCs in the emulsified product. One of the main advantages of the emulsification process is that the alkyd resin used in this application does not necessarily need to be altered to prepare the emulsion, as long as the proper surfactant and emulsification process is used to make the product. The proper surfactant is one with the proper molecular weight, structure, and HLB. The process is known to those that are skilled in the art of emulsification processing. U.S. Pat. No. 6,780,910 Bouvy et al. describes methods to prepare alkyd emulsions.

In Zükert et al. U.S. Pat. No. 3,979,346, it is proposed to prepare aqueous dispersions of alkyd resins by the use of a hydrophilic polyoxyethylene non-ionic emulsifier containing two or more unsaturated fatty alcohol or fatty acid groups, together with an anionic surfactant containing carboxylic acid groups prepared from a drying oil and maleic anhydride, which is hydrolyzed in the process. The properties of such dispersions are far from optimal, and coatings prepared therefrom may absorb water and hydrolyze.

McNamee et al. U.S. published application US 2007/0299228 disclose the use of branched polyoxyalkylene surfactants modified by reaction with an unsaturated fatty acid so as to contain more than one unsaturated fatty acid group. Preferred are fatty acid reaction products of polyoxyethylated sugars such as sorbitol. Due to the hydrophilic nature of the surfactant, water resistance of coatings prepared therefrom may be compromised.

### SUMMARY OF THE INVENTION

It has now been surprisingly discovered that improved waterborne alkyd coatings can be produced from aqueous emulsions or dispersions of alkyd resins, where the surfactant is a linear nonionic surfactant reactive with the alkyd resin in conventional coating processes. The surfactants are preferably nonionic polyoxyalkylene polyethers prepared by polyoxyalkylating an unsaturated initiator molecule, preferably an unsaturated fatty acid or mixture thereof, but may also include anionic or cationic surfactants, with or without polyoxyalkylene moieties.

### DETAILED DESCRIPTION OF THE PREFERRED EMBODIMENT(S)

The present invention thus involves synthesizing a special surfactant or emulsifier preferably using unsaturated fatty acids that are found in natural drying oils as the initiator of polyoxyalkylation. The drying oil, such as soya oil or linseed oils are processed to give products like soya fatty acid and linseed fatty acid, which are a mixture of fatty acids. These fatty acids can be converted into fatty alcohols by reduction. Fatty acids are preferred, since these are also generally a component of conventional alkyd resins, and thus no compatibility problems are anticipated. However, other unsaturated compounds can be used as well, as described hereinafter.

The fatty acids are converted into surfactants by oxyalkylation with ethylene oxide (EO), together with propylene oxide (PO) or butylene oxide (BO). Other alkylene oxides may also be used, for example long chain α-olefin oxides, but EO, and PO or BO are preferred, EO and PO being most preferred. A method for making ionic surfactants is to make them anionic by the addition of an anionic group such as a sulfate or a phosphate group onto a polyoxyalkylated fatty acid.

Another method by which to make the surfactant reactive is to make a surfactant starting with a product with functionality that allows the surfactant to react with the curing process of the coating. The chemistry of these initiators must contain one or more double bonds and subsequently reacted with EO, and PO or BO, or an anionic species, to prepare a surfactant. Some initiators for this application include but are not limited to the following products:

| Common Name | IUPAC Name | CAS Number | Formula |
|---|---|---|---|
| Allyl carbinol | 3-Buten-1-ol | 627-27-0 | C₄H₈O |
| Methyl vinyl | 3-Buten-2-ol | 598-32-3 | C₄H₇O |
| carbinol | | | |
| Vinyl acetic acid | 3-Butenoic Acid | 625-38-7 | C₄H₆O₂ |
| Crotonic acid | 2-Butenoic Acid | 107-93-7 | C₄H₆O₂ |
| Sorbic acid | 2,4-hexadienoic | 110-44-1 | C₆H₈O₂ |
| | Acid | | |
| 2,4-Pentadienoic | 1,2-Butadiene-1- | 626-99-3 | C₅H₆O₂ |
| acid | carboxylic Acid | | |
| Diallylamine | N,N | 124-02-7 | C₆H₁₁N |
| | Di(2propenyl)amine | | |

The surfactants are designed by selecting the EO/PO or BO architecture to produce a product that emulsifies, disperses and stabilizes the alkyd resin or hybrid latex/alkyd resin, without conferring hydrophilic properties. Further, the surfactant is preferably initiated from a drying oil such as linseed fatty acid or soya fatty acid or other functional initiators to make a nonionic surfactant, or functionalized with an anionic or cationic group. In general, therefore, the surfactants may be envisioned as having at least two portions; a first portion which is hydrophobic and which will promote formation of a clear coating during coalescence of alkyd resin from aqueous dispersion, and a second portion which is hydrophilic. At least one of these two portions, generally the hydrophobic portion, must contain unsaturation which is reactive with alkyd resins during cure.

It is well known and accepted that nonionic surfactants are excellent products to emulsify and disperse a wide range of hydrophobic compounds including alkyd resins. Nonionic surfactant outperform anionic surfactants in making stabilizing emulsions as demonstrated by improved water sensitivity, better colloidal stability and lower foam profile when compared to an emulsion made with an anionic surfactant. In some cases, those skilled in the art of making emulsions, a small amount of anionic surfactant is used in conjunction with the nonionic surfactant.

Alkyd resins are synthesized with drying oils as a major part of the formulation. Drying oils are liquid vegetable or fish oils that react with oxygen to form solid films. Drying oils are raw materials for binders such as alkyd resins and epoxy esters.

When these films are exposed to air, such as when the coating is curing, an autoxidative cross-linking reaction takes place. When a film is applied to a substrate, internal, naturally present hydroperoxides decompose to form free radicals. Hydrogen molecules on methylene groups between double bonds are particularly susceptible to abstraction, yielding a resonance stabilized free radical that reacts with oxygen to give predominantly conjugated peroxy free radicals. The peroxy free radicals can abstract hydrogen molecules from other methylene groups between double bonds to form additional hydroperoxides and generate free radicals. Thus, a cross-linking chain reaction is established, resulting from autoxidation and the coating is cured.

The preferred surfactant of this invention is initiated with a drying oil, such as linseed fatty acid, soya fatty acid or tung oil fatty acid. Natural oils such as linseed oil contain mixtures of fatty acids. Other oils such as soya also contain mixtures of fatty acids in various combinations. Preferred drying oils and analogous initiators contain two or more ethylenic unsaturations, and preferably conjugated double bonds.

Examples of fatty acids for this patent include but are not limited to the following products:

Linoleic acid CH₃(CH₂)₄CH═CHCH₂CH═CH(CH₂)₇COOH
Linolenic acid CH₃CH₂CH═CHCH₂CH═CHCH₂CH═CH(CH₂)₇COOH
Pinolenic acid CH₃(CH₂)₄CH═CHCH₂CH═CHCH₂CH₂CH═CH(CH₂)₃COOH

A preferred product of this instant invention is a surfactant initiated with soya fatty acid. Soya oil fatty acid contains fatty acids, consisting of approximately 15% saturated acids, 25% oleic acid, 51% linoleic acid and 9% linoleic acid. In addition to the unsaturated fatty acids soya fatty also contains a saturated component that includes stearic acid and palmitic acid. To this product, EO and PO and/or BO are added to a make a surfactant with a molecular weight (MW) of about 3000, a HLB of about 8.5 and containing approximately 42% PO and 47% EO in either a heteric (mixed) or block configuration. A currently preferred non-ionic inventive surfactant contains above 37% PO residues and 63% EO residues, with an HLB of about 11.7. It is noted that the initiator, and thus the final surfactant product, may also contain non-reactive hydrophobes. This is true for most common and inexpensive natural drying oil starting materials. However, the amount of non-reactive groups should be relatively low, for example but not by limitation, less than 25 mol % based on the entire surfactant.

The actual surfactant molecular weight and HLB will vary depending upon such factors as the nature of the particular alkyd resin, its weight percent concentration in the dispersion, the type of unsaturated material used to produce the surfactant, whether other surfactants are present, etc. A blend of inventive surfactants, one with a relatively high HLB and one with a lower HLB may be used, for example, as also may an inventive surfactant with a given HLB together with one or more conventional surfactants with the same, a higher, or a lower HLB. In general, the HLB of the inventive surfactants may range from about 3 to about 14, more preferably 4 to 13, and most preferably 8 to 12, and the overall HLB of the total of all surfactants may range from about 5 to 13, preferably 7 to 13, and most preferably about 8 to 12.

The oxyalkylation of the unsaturated initiator must be conducted with at least one higher alkylene oxide. Examples of higher alkylene oxides include propylene oxide, butylene oxide, and long chain α-olefin oxides. If the oxyalkylation is conducted with about 70% or more of ethylene oxide, it is important that the ethylene oxide residues are not contained in large blocks, or water resistance of the coating will be lessened. It is also important that a monofunctional initiator be used, otherwise the distributed ethylene oxide blocks will confer undesirable properties. Preferably, a monofunctional initiator such as an unsaturated fatty acid or fatty acid mixture be employed as an initiator, and a small proportion of a heteric PO/EO or BO/EO block is oxyalkylated onto the initiator, followed by further EO and PO or BO. The further oxyalkylation just described may take place in heteric fashion, block fashion, or block heteric fashion. The mol proportion of EO relative to higher alkylene oxides is preferably less than 50%, more preferably about 45% or less, and most preferably about or less than 40%.

In preferred non-ionic surfactants of the invention, the total of alkylene oxide units in the surfactant, based on the total weight of the surfactant, ranges from 80% to 99%, more preferably 85% to 98%, and most preferably 88% to 94%. Of this alkylene oxide content, the proportion of ethylene oxide units relative to the total weight of the surfactant is preferably from 30% to 60%, more preferably 40% to 60%. The higher alkylene oxide(s) which constitutes the remainder are preferably PO, BO, or higher alkylene oxides or mixtures thereof, more preferably PO and/or BO, and most preferably, PO. The molecular weight of the surfactant is preferably in the range of 2200 Daltons to 4500 Daltons, more preferably 2500 Daltons to 4000 Daltons, and most preferably 2700 to about 3700 Daltons. In a most preferred surfactant based on oxyalkylating an unsaturated fatty acid initiator such as linolenic acid, the total alkylene oxide content will be about 91.5% by weight, with EO constituting about 57.5% by weight and the remainder being PO, with a molecular weight of about 3720.

The surfactant prepared as above must be employed in the subject invention alkyd resin dispersions However, as mentioned earlier, the emulsification system may also include anionic surfactants. Such ionic surfactants may easily be prepared from the non-ionic surfactants of the invention by esterification, of the residual polyether hydroxyl group with an acid such as sulfuric acid, sulfamic acid, phosphoric acid, or precursors thereof such as methylsulfate, or by other chemical process known to those skilled in the art. The co-use of such surfactants confers advantageous dispersion properties without rendering the coating hydrophilic.

Method of Surfactant Incorporation into the Alkyd

In the actual use of this invention, the reactive surfactant that emulsified the alkyd resin is in close, intimate contact with the emulsified alkyd resin, including the drying oil potion of the resin that was used to synthesize the alkyd resin. As the autoxidation chain reaction is initiated, the drying oil nonionic, or anionic surfactant will participate in the autoxidation curing, cross-linking chain reaction. The surfactant will be part of the cured alkyd resin. The autoxidation reaction is catalyzed by compounds commonly known as dryers or siccatives, which are metal salts. The most widely used driers are cobalt, manganese, lead, zirconium and calcium.

It is well known and accepted that the surfactant used in emulsion polymerization or other polymerization processes is a necessary evil. The surfactant is needed to emulsify and stabilize the polymer. However, as the surfactant which cover and surrounds the emulsion particles will bloom to both film surfaces of the substrate as the emulsion particles coalesce into a continuous film. This phenomenon occurs as the surface area changes as the particles coalesce and forms a film.

A lower concentration of surfactant is needed in an emulsion polymerization process if the surfactant is reactive in the process and participates in the polymerization process. Water sensitivity, colloidal and mechanical stability and toughness properties will increase in the polymer system if the surfactant used in the polymerization process is a reactive surfactant.

This invention will give the waterborne alkyd coatings properties more like solvent borne alkyd coatings. This is due to the enhanced film properties and the lower concentration of the reactive emulsifier that will be used to emulsify the alkyd resin. This reactive surfactant will be used to emulsify, disperse and stabilize the alkyd or epoxy resins.

In a second embodiment, the nonionic surfactants of this structure can be used in emulsion polymerization as a reactive surfactant to synthesize acrylic polymers either by emulsion polymerization or dispersion polymerization. Salter et al., U.S. Pat. No. 6,335,314 “Anionic Alkoxylated Surfactant from Conjugated Unsaturated Alcohol”, teaches that unsaturated fatty alcohols when ethoxylated and made into an anionic product are useful products in emulsion and dispersion polymerization.

In a third embodiment of this invention, as mentioned above, coalescing solvents are optional additives for the waterborne alkyd coatings, emulsion and dispersion applications. Most coalescing solvents are slowly fugitive from the cured film and therefore will eventually leave the film into the atmosphere. This adds to VOC levels and, as the coalescing solvent leaves the film the film will become brittle and stiff as the coalescing agent leaves the film. If the coalescing solvent is attached to the cured film, it will not leave the film and the film will exhibit better longer lasting film properties. The subject invention is thus also directed to preparing a molecule that will act as a coalescing additive and will react into the curing film by autoxidative curing. For example, a coalescing additive may be prepared from a drying oil like linseed fatty acid with 8-15 moles of PO or BO and/or a low level of EO in addition to the PO or BO block. These products may be used in mixtures as well. The EO/PO and/or BO levels will depend on the particulars of the polymer and application conditions. This molecule will perform as a coalescing solvent while reacting into the curing film. However, conventional coalescing solvents may be used as well, particularly solvents which are miscible with water in the concentrations used, and preferably those with low ozone depletion characteristics. Examples include t-butylacetate, isopropyl acetate, ethyl acetate, acetone, methylethylketone, and the like. Such solvents are well known to those skilled in the art.

The aqueous alkyd resin dispersions of the invention preferably contain, based on the total weight of the dispersion,

(a) from 10 to 20% by weight, preferably from 7 to 14%, and more preferably from 2 to 6% of the reactive, non-ionic emulsifier of the present invention;

(b) from 0 to 15 weight percent, preferably from 5 to 10% and more preferably from 2 to 3% of a reactive, polyoxyalkylene anionic emulsifier;

(c) from 0 to 9 weight percent, preferably 5 to 7%, and more preferably 3 to 2% of additional surfactants of the anionic or cationic type, preferably

(d) from 0 to 9 weight percent, preferably from 5 to 7%, and more preferably from 0.3 to 3% of base, preferably ammonia;

(e) from 10 to 20 weight percent, preferably 20 to 30%, and preferably from 30 to 60% of one or more alkyd resins;

(f) from 0 to 8 weight percent, preferably 3 to 5%, and more preferably from 1 to 2% of further conventional additives, including water miscible organic solvents, preferably those with low greenhouse warming potential, antioxidants, UV stabilizers, biocides, flow control additives, coalescing agents, and the like,

balance water. For pigmented alkyd dispersions, conventional pigments, dyes, and fillers may be added to the composition described above, but are not counted in determining the weight percentages described above.

When coalescing solvents are used, they are preferably used in minor amounts, preferably less than 10 weight percent based on the total weight of the dispersion, more preferably less than 5 weight percent, and most preferably less than 3%. In addition, the composition may also include other customary alkyd resin ingredients, including but not limited to adhesion promoters, plasticizers, pigments, fumed or colloidal silica or other finely divided metal oxides such as alumina, titania, and the like, and catalysts which promote cure, particularly oxidative cure, including metal compounds such as tin compounds, titanium alkoxides, and the like.

### EXAMPLES

### Example 1

### Synthesis—Nonionic Reactive Emulsifier

300 g. of linseed fatty acid and 3.9 g of 90% KOH are charged into autoclave fitted with heating, stirring and pressure metering devices. The mixture is stirred while heating to 70° C. Vacuum is applied to strip off water from the catalyst until the water level is between 0.05 and 0.1%. The autoclave is then heated to 120° C. with stirring, and 1144 g PO is added at a rate to keep the internal pressure in the autoclave below 90 psig. If the autoclave pressure reaches 90 psig, the oxide feed is stopped to allow the PO to react out until a steady pressure is reached, the excess PO is vented to atmospheric pressure, and PO feed is resumed. This process is repeated as needed. At the end of the PO charge, the autoclave is reacted to constant pressure, vented to atmospheric pressure, and heated to 140° C. The autoclave is then pressurized to 34 psig with nitrogen, and a feed of 1191 g EO is begun at a rate to keep the internal autoclave pressure below 90 psig. The contents are reacted to constant pressure, vented to atmospheric pressure, and cooled to 80° C. Based on total weight, the product contains about 9.9% LFA, 50.0% PO, and 40% EO, the approximate MW is 2980, and the OH# is approximately 18.8.

The product can be used in un-neutralized state or it can be neutralized with an acid such as acetic acid or phosphoric acid. The theoretical OH value is 16.1.

### Example 2

### Synthesis—Anionic Reactive Emulsifier

There are many processes available to add anionic functionally to the terminal OH group of the nonionic reactive emulsifier molecule including phosphate esters groups, carboxylic acid groups, sulfonate groups and sulfate groups. Those skilled in the art of organic synthesis will readily be able to make these additions. As an example, a sulfate functional reactive emulsifier is synthesized. This synthesis requires a two step process. One step to make the nonionic product and another step to add the sulfate group.

The nonionic product, step 1 is made with the method described in Example 1 with the following charges:

| | |
|---|---|
| Linseed fatty acid | 900 g |
| 90% KOH | 1.5 g |
| PO (block) | 360 g |
| EO (block) | 378 g |

Theoretical OH number˜102

### The Anionic Reactive Emulsifier

1532.0 g of step 1 material is charged into a pound bottom flask fitted with stirring, heating and a nitrogen inlet. 1.4 g dicyandiamide, a catalyst, is added and the mixture is heated to 80° C. while nitrogen is swept over the surface of the reactants. When the mixture is at 80° C., 144.0 g sulfamic acid is added over a 15 minute period of time, and the temperature exotherms, and flask cooled to 100° C. if necessary. The reaction mixture is held at 100° C. for 4 hours, cooled to 40° C., and decanted.

### Examples

### Application-Emulsification

These reactive emulsifiers can be used in direct or preferably, in an inversion emulsification processes. The inverse procedure is preferred due to better emulsion properties like stability, lower viscosity and higher solids of the emulsion. The direct method is one in which the emulsifier is added to the water and base. The resin is heated and stirred while the heated water, emulsifier and base are added to the resin. The preferred base is ammonia.

The inversion method is one where the emulsifier is added to the resin and heated. The temperature reached is dependent on the resin type, i.e. to a temperature at which the resin is at least fluid. A somewhat higher temperature to reduce fluid viscosity of the resin may be preferred. Since the emulsification is done at atmosphere pressure, the resin has to be fluid below 100° C. Warm to hot water containing a base for resin neutralization is added to the resin and emulsifier mixture. Initially, this mixture forms a high viscosity mixture of an oil in water emulsion (O/W). There comes a point where the viscosity of the O/W emulsion, with the continued addition of water/base mixture, greatly drops and the emulsion inverts to a water in oil (W/O) emulsion when the Emulsion Inversion Point (EIP) is reached. Additional water is added to prevent back conversion to an O/W emulsion.

### Emulsification Process

The alkyd emulsions were made by the inverse emulsification method. Emulsions were made in 200 ml batches. The emulsions were prepared with overhead stirring with a propeller blade with the resin at 70-80° C. The water and base mixture is at 50-60° C. The water/base mixture is added over a 15-20 minute period of time. The emulsion is slowly cooled to room temperature. If the viscosity is too high, greater that 2500 cps, an anionic reactive emulsifier from Example 2 can be added. The amount added depends on the resin type and the viscosity of the emulsion. Typically, the anionic emulsifier is in the range of 1-2% of the resin. In addition to the charge of the anionic emulsifier to reduce viscosity, the emulsion viscosity can be reduced (and possibly stabilized) by mixing the emulsion with standard rotary mixer with a Cowles blade at 750-1000 rpm.

### Example 3

A commercial long oil resin, Beckosol® 10-539 (88-92% active) was obtained from Reichhold and used in this example. 88.8 g of Beckosol 10-539 was added to a beaker along with 6.4 g of Example 1 and heated to 70° C. with stirring. In another beaker, 0.6 g of ammonia was added to 103.2 g D.I. water and heated to 50° C. The water was added over a 15 minute period. The initial viscosity was 4600 cps. 1.6 g of anionic reactive emulsifier from Example 2 was added to the emulsion that was at 50° C. and stirred for 15 minutes and cooled to room temperature. The final viscosity was 2200 cps. The emulsion was stable and had light color. The emulsion is catalyzed with metallic salts and drawdown on a Leneta sheet with a 3 mil Byrd applicator. The dried film was high in gloss at 92.3 (60°) and the film had good appearance.

### Example 4

A commercial long oil resin was obtained. The alkyd emulsion was 98% active and pourable at 50° C. and above. 449 g of this alkyd resin was added to a beaker along with 44 g of Example 1. The mixture was heated and stirred to 75° C. In another beaker 501 g of D.I. water along with 3.0 g ammonia, 34% aq. and heated to 50-55° C. The water material was added to the resin and emulsifier mixture over a 15-20 minute period. The emulsion was cooled to 40° C. The emulsion was exposed to high shear stirring conditions for 40 seconds. The emulsion had a viscosity of 630 cps and was very stable to separation. The material was drawdown on a Leneta sheet with a 3 mil Byrd applicator, the dried film was glossy, hard with few imperfections.

### Example 5

A commercial medium oil alkyd resin was obtained from a major U.S. coating supplier. The resin was 90% active and a 45% solids emulsion using 10% material from Example 1 was made. 100 g of this resin was charged into a beaker along with 9.0 g of material from Example 1. This mixture was heated to 75° C. with stirring. In another beaker, 90.4 g water and an amine was charged into a beaker and heated to 50-55° C. The water mixture was added to the resin and emulsifier mixture over a 15-20 minute period. The emulsion was slowly cooled to room temperate and decanted. The viscosity was 220 cps. The emulsion dried to a hard glossy film with a gloss rating of 95.6 GU at 60° and also was a stable emulsion.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An aqueous alkyd resin coating composition, comprising
a) at least one alkyd resin as a dispersed phase;
b) an emulsifier, comprising
b)i) at least one polyoxyalkylene nonionic emulsifier containing a single unsaturated hydrocarbon moiety bonded to a polyoxyalkylene polyether comprising residues of ethylene oxide and at least one higher alkylene oxide;
b)ii) optionally an anionic polyoxyalkylene emulsifier comprising at least one unsaturated hydrocarbon moiety bonded to a polyoxyalkylene polyether further containing an anionic group; and
b)iii) optionally, further emulsifiers different from b)i) and b)ii); and
c) water.

2. The coating composition of claim 1, wherein the nonionic emulsifier b)i) is a polyoxyalkylated unsaturated fatty acid, unsaturated fatty alcohol, or mixtures thereof.

3. The coating composition of claim 2, which contains at least one nonionic emulsifier b)i) which contains ethylene oxide and propylene oxide residues in a heteric, block, or block heteric arrangement.

4. The coating composition of claim 3, wherein the non-ionic emulsifier b)i) is capped with a saturated C₁₋₁₈ hydrocarbon group.

5. The coating composition of claim 2, wherein both emulsifiers b)i) and b)ii) are present.

6. The coating composition of claim 1, which contains 10-60% by weight of alkyd resin as a dispersed phase.

7. The coating composition of claim 1, wherein the emulsifier b)i) is present in an amount of from 2 to 20 weight percent based on the weight of the dispersion.

8. The coating composition of claim 1, wherein the nonionic emulsifier b)i) is prepared by oxyalkylating an unsaturated fatty acid with a mixture of ethylene oxide and higher alkylene oxide, followed by further oxyalkylation with at least one higher alkylene oxide, and optionally also with ethylene oxide.

9. The coating composition of claim 8, wherein the nonionic emulsifier b)i) contains 30 to 45 mol % ethylene oxide and 70 to 55 mol percent of higher alkylene oxide.

10. The coating composition of claim 1, wherein the nonionic emulsifier b)i) has an HLB in the range of 3 to 14.

11. The coating composition of claim 1, wherein the nonionic emulsifier b)i) has an HLB in the range of 4 to 13.

12. The coating composition of claim 1, wherein the HLB of combined surfactants b)i), b)ii), and b)iii), is from 5 to 13.

13. The coating composition of claim 1, wherein the HLB of combined surfactants b)i), b)ii), and b)iii), is from 8 to 12.
